(19) United States
(12) Patent Application Publication
(10) Pub. No.: US 2020/0019336 A1
(43) Pub. Date: Jan. 16, 2020

(54) NOVEL METHOD FOR OFFLOADING AND ACCELERATING BITCOUNT AND RUNLENGTH DISTRIBUTION MONITORING IN SSD

(71) Applicants: Samsung Electronics Co., Ltd., Suwon-si (KR); Stellus Technologies, Inc., San Jose, CA (US)

(72) Inventors: Ramdas P. KACHARE, Pleasanton, CA (US); Fred WORLEY, San Jose, CA (US); Abhijit APHALE, Pleasanton, CA (US)

(21) Appl. No.: 16/140,521

(22) Filed: Sep. 24, 2018

Related U.S. Application Data
(60) Provisional application No. 62/696,729, filed on Jul. 11, 2018.

(51) Int. Cl. G06F 3/06; G06F 11/34

(52) U.S. Cl. CPC G06F 3/0653; G06F 3/0614; G06F 11/34; G06F 3/0679; G06F 3/0658

(57) ABSTRACT

According to one general aspect, an apparatus may include a host interface circuit configured to facilitate communication of memory accesses, for a storage memory, between the apparatus and a host device. The apparatus may include a statistics monitor circuit configured to record, as the memory accesses occur, statistics regarding data associated with the memory accesses. The apparatus may include a memory interface circuit configured to communicate the memory accesses between the apparatus and at least one storage memory.

### CROSS-REFERENCE TO RELATED APPLICATION

This application claims priority under 35 U.S.C. § 119 to Provisional Patent Application Ser. No. 62/696,729, entitled “A NOVEL METHOD FOR OFFLOADING AND ACCELERATING BITCOUNT AND RUNLENGTH DISTRIBUTION MONITORING IN SSD” filed on Jul. 11, 2018. The subject matter of this earlier filed application is hereby incorporated by reference.

### TECHNICAL FIELD

This description relates to NVM memory or storage media such as flash management and more specifically to a method for off-loading and accelerating bit count and run length distribution monitoring in solid state devices (SSDs).

### BACKGROUND

Non-volatile memory (NVM) Express (NVMe) or Non-Volatile Memory Host Controller Interface Specification (NVMHCIS) is an open logical device interface specification for accessing non-volatile storage media attached via a Peripheral Component Interconnect (PCI) Express (PCIe) bus. Often the non-volatile memory, is NAND or NOR flash memory that comes in several physical form factors, including solid-state drives (SSDs), PCI Express (PCIe) add in cards, and other forms, such as, M.2 cards. NVM Express, as a logical device interface, has been designed from the ground up to capitalize on the low latency and internal parallelism of solid-state storage devices.

By its design, NVM Express allows host hardware and software to more fully exploit the levels of parallelism possible in modern SSDs. As a result, NVM Express reduces input/output (I/O) overhead and brings various performance improvements relative to previous logical-device interfaces, including multiple, long command queues, and reduced latency.

One limitation of flash memory is that, although it can be read or programmed a byte or a word at a time in a random access fashion, it can be erased only a block at a time. This generally sets all bits in the block to 1. Starting with a freshly erased block, any location within that block can be programmed. However, once a bit has been set to 0, only by erasing the entire block can it be changed back to 1.

### SUMMARY

According to one general aspect, an apparatus may include a host interface circuit configured to facilitate communication of memory accesses, for a storage memory, between the apparatus and a host device. The apparatus may include a statistics monitor circuit configured to record, as the memory accesses occur, statistics regarding data associated with the memory accesses. The apparatus may include a memory interface circuit configured to communicate the memory accesses between the apparatus and at least one storage memory.

According to another general aspect, a system may include a host device configured to process instructions and, via a storage driver, issue memory accesses. The system may include an intermediate memory manager circuit. The intermediate memory manager circuit may include a host interface circuit configured to facilitate communication of memory accesses, for a storage memory, between the intermediate memory manager circuit and the host device, a statistics monitor circuit configured to record, as the memory accesses occur, statistics regarding the memory accesses, and a memory interface circuit configured to facilitate communication of the memory accesses between the intermediate memory manager circuit and at least one storage memory. The system may include at least one storage memory configured to store data and process memory accesses.

According to another general aspect, an apparatus may include a processor configured to process instructions and generate memory accesses. The apparatus may include a storage management circuit. The storage management circuit may be configured to offload collection of statistics associated with a storage device to an external statistics monitor circuit, dynamically receive information regarding the statistics as part of a response to a memory access, initiated by the storage management circuit, and based at least in part upon the statistics, alter future memory accesses.

The details of one or more implementations are set forth in the accompanying drawings and the description below. Other features will be apparent from the description and drawings, and from the claims.

A system and/or method for NVM storage media storage management and more specifically to a method for off-loading and accelerating bit count and run length distribution monitoring in solid state devices (SSDs), substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2A is a block diagram of an example embodiment of a system in accordance with the disclosed subject matter.

FIG. 2B is a block diagram of an example embodiment of a system in accordance with the disclosed subject matter.

FIG. 3A is a diagram of an example embodiment of a data structure in accordance with the disclosed subject matter.

FIG. 3B is a table of an example embodiment of commands in accordance with the disclosed subject matter.

FIG. 3C is a table of an example embodiment of commands in accordance with the disclosed subject matter.

FIG. 4 is a diagram of an example embodiment of a data structure in accordance with the disclosed subject matter.

FIG. 5 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it may be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, and so on may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Likewise, electrical terms, such as “high” “low”, “pull up”, “pull down”, “1”, “0” and the like, may be used herein for ease of description to describe a voltage level or current relative to other voltage levels or to another element(s) or feature(s) as illustrated in the figures. It will be understood that the electrical relative terms are intended to encompass different reference voltages of the device in use or operation in addition to the voltages or currents depicted in the figures. For example, if the device or signals in the figures are inverted or use other reference voltages, currents, or charges, elements described as “high” or “pulled up” would then be “low” or “pulled down” compared to the new reference voltage or current. Thus, the exemplary term “high” may encompass both a relatively low or high voltage or current. The device may be otherwise based upon different electrical frames of reference and the electrical relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

Another limitation is that flash memory has a finite number of program-erase cycles (typically written as P/E cycles). Some flash products are guaranteed to withstand around 1,000 to 10,000 P/E cycles for Multi-level cell (MLC) and Triple-level cell (TLC) before the wear begins to deteriorate the integrity of the storage. The guaranteed cycle count may apply only to block zero (as is the case with TSOP NAND devices), or to all blocks (as in NOR). This effect is mitigated in some chip firmware or file system drivers by counting the writes and dynamically remapping blocks in order to spread write operations between sectors; this technique is called wear leveling. Another approach is to perform write verification and remapping to spare sectors in case of write failure, a technique called bad block management (BBM). Yet another technique is re-distributing the order of data such that the data is written in a way that less programs occur. This is known as scrambling.

For these and various other reasons statistics regarding the flash memory read/write accesses are often gathered or desired. Frequently it involves the main processor of a system mirroring such storage media memory accesses (read, writes or programs and erases in the parlance of flash memory) and analyzing them off-line or after the NVM memory access has occurred.

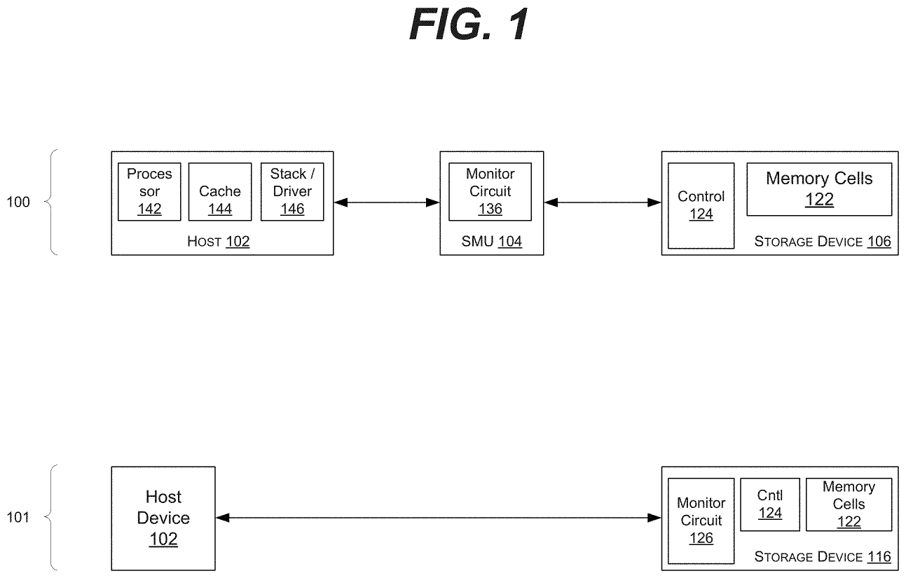

FIG. 1 is a block diagram of an example embodiment of systems 100 and 101 in accordance with the disclosed subject matter. In various embodiments, the systems 100 and 101 may allow for the storage of data via memory accesses (e.g., reads, writes, or programs and erasures, to use the parlance of flash memory). In such an embodiment, the system 100 may be configured to provide real-time or in-line monitoring of the memory accesses, as described below.

In this context a “memory access” is a flash storage memory access. Such a memory access may include a program or erasure to a flash memory, and should not be confused to with a memory access made to a host system memory (e.g., DRAM) that is volatile and not persistent.

In various embodiments, the systems 100 and 101 may include a computing device, such as, for example, a laptop, desktop, workstation, personal digital assistant, smartphone, tablet, and other appropriate computers or a virtual machine or virtual computing device thereof. In various embodiments, the systems 100 and 101 may be used by a user (not shown).

In various embodiments, the systems 100 and 101 may include a host device 102. In such an embodiment, the host device 102 may include a processor 142. The processor 142 may be configured to execute one or more machine executable instructions or pieces of software, firmware, or a combination thereof. In various embodiments, the host device 102 may include a cache 144. In such an embodiment, the cache 144 may be configured to store one or more pieces of data, either temporarily, permanently, semi-permanently, or a combination thereof. Further, the cache 144 may include volatile memory, non-volatile memory or a combination thereof. In the illustrated embodiment, the host device 102 may include a storage stack or driver 146. In such an embodiment, the storage stack or driver 146 may include a piece of software configured to manage and issue memory accesses.

In the illustrated embodiment, the system 100 may include an embodiment that includes an intermediate or intervening storage management circuit 104, such as a storage management unit (SMU) of an NVMe bridge (e.g., NVMe-to-NVMe bridge, NVMe-to-NVMe-oF bridge); although, it is understood that the above is merely one illustrative example to which the disclosed subject matter is not limited. In such an embodiment, the SMU 104 may include a computer hardware unit or circuit controlling all or most memory access and management between the host device 102 and any storage devices 106. In some embodiments, the SMU 104 may be configured to have all memory accessed passed through it, primarily performing the translation of virtual memory addresses to physical addresses, and routing such memory accesses.

In various embodiments, the SMU 104 may be included in the host device 102. In such an embodiment, the host device 102 may include a central processing unit (CPU), system-on-a-chip (SoC), multi-chip module (MCM) or other highly integrated device. It is understood that the above are merely a few illustrative examples to which the disclosed subject matter is not limited.

In the illustrated embodiment, the system 100 may include one or more storage devices 106. In such an embodiment, the storage device 106 may include non-volatile memory, such as flash memory or more specifically NVMe compliant memory. In such an embodiment, the storage device 106 may include memory cells 122 to store data, and a controller processor 124 to management and perform any memory accesses received from the SMU 104.

As described above, some storage devices (e.g., flash, SSD, non-volatile memories) wear out and often at a predictable rate. As such, a great deal of effort goes into how to best use those storage devices (e.g., storage device 106). To aid in that usage, it would be advantageous to have up to date, reliable, and relatively low cost statistics on the data stored by the storage device and how that data is used.

Traditionally, one solution is to execute an application or driver on the host device 102 to obtain the user data and then process it. This usually involves making a mirror or shadow copy of the data and then using processor 142 cycles to analyze it. In some other solutions complex snooping or data interception methods are employed to obtain the desired data statistics and other data characteristics.

These solutions may consume a number of processor cycles as well as put constrains on other host device resources, such as memory and network bandwidth. These solutions may impact latency/bandwidth performance of normal storage accesses.

In the illustrated embodiment, a method and solution is provided by which these data characteristics monitoring functions can be offloaded (i.e., moved off the host device 102—or at least the processor 142—and performed by another device) as well as accelerated using the storage devices. By offloading these functions to another device, these desired data statistics can be obtained in near real time without incurring huge costs in terms of host device's 102 resources.

Further, traditionally, storage systems do not know the compressibility of user data being stored. Moreover, the data stored in the storage systems tends to be heterogeneous with varying compressibility. The decision to compress the data is usually either done based on some heuristic (e.g., exclude certain file types or extensions from compression) or indiscriminately at a gross storage unit level (compress all contents of this directory tree, compress all data in this volume).

In the illustrated embodiment, a monitoring device, when enabled or when the job of monitoring is offloaded to it, may compute various statistics of the data being written or read from the storage device 106. The computed statistics may be read by the host application using special commands or as part of the normal memory access process. Host applications may use special commands to configure and monitor statistics functionality. A host device 102 may also set a threshold which can be used to monitor any statistical values above the programmed threshold. The host device 102 may periodically query and read these statistics and build a database over long period of time.

In dynamic mode of operation, statistical values can be returned to the host in each storage IO command completion. In such an embodiment, offloading this functionality to a monitoring device may relieve compute resources from the host device 102.

In the illustrated embodiment, system 100 may more specifically the intermediate or intervening storage management circuit or SMU 104 may include a statistics monitor circuit 136. In such an embodiment, as a memory access passes through the SMU 104, the statistics monitor circuit 136 may read the memory access and record statistical information about the memory access. In some embodiments, this statistical information may be created or monitored as the memory access is going to the storage device 106 (e.g., during the memory access request phase or message). In another embodiment, this statistical information may be created or monitored as the memory access is going to the host device 102 (e.g., during the memory access response phase or message). In yet another embodiment, the statistical information may be created or monitored during both phases or messages. In such an embodiment, the statistical information may be recorded while the data or memory access is in-flight to the target device (e.g., storage device 106 or host 102), as opposed to the mirroring and later analysis traditionally done.

In various embodiments, monitoring may be done on one or more statistical characteristics of the data. Examples may include bit count, run length distribution (RLD), and various frequency/interval inference statistical parameter, probability distributions, descriptive statistics parameters, as well as various statistical transforms used for data analysis. Some examples are given below:

Point estimation such as maximum likelihood, minimum distance, interval estimation such as confidence interval, pivot, likelihood interval, prediction interval, tolerance interval. Normal distribution, Poisson distribution, Binomial distribution, exponential distribution, mean (arithmetic, geometric, harmonic), median, mode, variance, standard deviation, coefficient of variation, linear predictive co-efficient, central limit theorem percentile, range, index of dispersion, frequency distribution, grouped data, contingency table, rank correlation, partial correlation, scatter plot, bar chat, biplot, box plot, control chart, correlogram, fan chart, forest plot, histogram, pie chart, run chart, Q-Q chart, radar chart. Transforms such FFT (Fast Fourier Transform) and DFT (Discrete Fourier Transform) and DCT (Discrete Cosine Transform).

To highlight various usage cases of the illustrated embodiment, uses of monitoring bit count and RLD are described in detail below. However, it is understood that the above are merely a few illustrative examples to which the disclosed subject matter is not limited.

Bit count may be an operational mode that counts number of 1s or 0s in a dataset, specifically data associated with one or more memory accesses, a region of memory, or other definable groups, as described below. In an ideal data set number of 1s and 0s in the data would be half and half. In such an embodiment, the amount of wear on an NVM device may be minimized. However, data sets rarely include the ideal number of is and 0s.

Because traditional Flash memories start with their memory cells values set to 1, each writing of a 0 and subsequent erase to a 1 represents wear on the device. In such an embodiment, the number of 0s being written may correlate with the amount of wear the device is experiencing. Or more generally, the number of P/E cycles being consumed.

If the host device 102 knows that a particular SSD or a region in SSD such as NVM Set or flash channel is experiencing a high number of P/E cycles, data may be moved to another region of a SSD, or different SSD. Or, more often, data may be scrambled. Scrambling is a reversable process in which data is re-encoded (e.g., via a linear feedback shift register (LFSR)) to make the number of 1s and 0s more equal and hence closer to the ideal. In various embodiments, scrambling may make the number of 1s and 0s more equal in the immediate sense or more equal over a period of time.

In various embodiments in which bit count is being monitored, the host device 102 or the storage driver 146 may instruct the statistic monitor circuit 136 to monitor bit counts. In various embodiments, this may occur by writing a value to a predefined memory location. In another embodiment, as described below, this may be done by issuing a special NVMe command or a NVMe command with special fields to the statistic monitor circuit 136 and/or 126, either directly or as part of a memory access.

Once configured, the statistic monitor circuit 136 may read each memory access and, if warranted, adjust its bit count. In various embodiments, this bit count may be for the memory as a whole or for a region of memory. In such an embodiment, multiple bit counts may exist for various regions, groups, or buckets of the memory. As described above, this reading or monitoring may occur while the memory access is being performed or “in-flight”.

In one embodiment, as part of the response phase or message of the memory access, the statistic monitor circuit 136 may report to the host device 102 what the current bit count is. In another embodiment, the host device 102 may make periodic requests for the bit count. In one embodiment, this may include making a read memory access to a predefined memory location where the bit count is stored. It is understood that the above are merely a few illustrative examples to which the disclosed subject matter is not limited.

In such an embodiment, host device 102 may decide whether or not to scramble future memory accesses. For example, if the bit count is becoming skewed (e.g., too make 0s) the host device 102 may choose to scramble future memory accesses in an attempt to offset the wear on the storage device 106. In some embodiments, this decision may be based upon a threshold value. In another embodiment, the host device 102 may be configured to store data on a second or other storage device 102 (e.g., in a system with a plurality of storage devices). It is understood that the above are merely a few illustrative examples to which the disclosed subject matter is not limited.

In various embodiments, the bit count statistic may be used to estimate the endurance or lifetime of the storage device 106. In such an embodiment, an estimated number of P/E cycles may exist for the storage device 106 and as the bit count indicates P/E cycles are used the endurance of lifetime of the storage device 106 may be estimated.

Run length distribution (RLD) involves counting the number of continuous 1s and 0s in a dataset. In an ideal dataset the large sized run lengths are minimal, as the longer one is storing the same data over and over again, the more space one is wasting. The run-length distribution reflects the compressibility of the data and may correlate to the performance of compression or de-duplication (de-dup) techniques. For example, a simple compression scheme could involve reducing all run lengths or run lengths above a certain threshold to a notation instead of the actual values. In such an embodiment, instead of storing a run of 256 1s, a single 1 may be stored and a notation that is should continue for 256 times may also be stored. In such an embodiment, data may be stored in a compressed format. It is understood that the above is merely one illustrative example to which the disclosed subject matter is not limited. In various embodiments in which RLD is being monitored, the host device 102 or the storage driver 146 may instruct the statistic monitor circuit 136 to monitor RLD. In various embodiments, this may occur by writing a value to a predefined memory location. In another embodiment, as described below, this may be done by issuing a special command or a command with special fields to the statistic monitor circuit 136, either directly or as part of a memory access.

Once configured, the statistic monitor circuit 136 may read each memory access and compute an RLD, either just for that memory access or for the data surrounding and including the memory access. As described above, this reading or monitoring may occur while the memory access is being performed or “in-flight”.

In one embodiment, as part of the response phase or message of the memory access, the statistic monitor circuit 136 may report to the host device 102 what the memory accesses RLD was. In another embodiment, the host device 102 may make periodic requests for the RLD. In one embodiment, this may include making a read memory access to a predefined memory location where the bit count is stored. It is understood that the above are merely a few illustrative examples to which the disclosed subject matter is not limited.

In such an embodiment, host device 102 may decide whether or not to compress future memory accesses or to later compress the immediately completed memory access. For example, if the RLD exceeds a threshold value the host device 102 may choose to compress memory accesses in an attempt to reduce used storage space.

In various embodiments, the host device 102 may wait until an off-peak period or period of low activity, and request that the data of the memory access be compressed. In another embodiment, the host device 102 may wait until the data is considered “cold” or relatively inactive, and thus unlikely to be changed, before requesting that it be compressed. It is understood that the above are merely a few illustrative examples to which the disclosed subject matter is not limited.

In various embodiments, the RLD statistical data may help to determine not only if a compression technique may be employed, but what compression technique should be employed. For example, a simple RLD compression scheme may be advantageous of data with long runs of constant values. However, in another embodiment, RLD or a similar statistical measurement may indicate that another compression technique may be more beneficial. For example, the statistic monitor circuit 136 may be configured to preform frequency analysis on the data, and as such more complex compression techniques (e.g., cosine transform) may be selected. In such an embodiment, the host device 102 may not just tell the storage device 106 to compress the data but what technique to use to do so.

In various embodiments, the statistic monitor circuit 136 may be configured to maintain RLD counts or other statistical counts based upon threshold levels, groups, or buckets. For example, the RLD counts may include counts of when the RLD exceeded run lengths of 16, 32, 48, 64, and so on bits. In such an embodiment, the actual number may not be important, or may not be the sole statistical data returned or kept. It is understood that the above is merely one illustrative example to which the disclosed subject matter is not limited.

Hence bit count and run length distributions are useful for NVM storage management applications. Monitoring of actual data characteristics such as bit count and RLD may influence techniques such as data scrambling, compression, de-duplication, and so on. Monitoring of these statistics may be used to enhance and improve management of endurance and other such characteristics of NVM storage. Such dataset characteristics may be used for various purposes such as selection of better compression techniques and estimates of remaining life endurance of deployed NVM storage.

In various embodiments, the level or region of data being monitored may be limited or adjustable. For example, in one embodiment, the statistic monitor circuit 136 may monitor all memory accesses, and all of the data in the storage device 106. In another embodiment, the statistic monitor circuit 136 may be limited to data for a single storage device 106 (in a system with a plurality of storage devices). In yet another embodiment, the statistic monitor circuit 136 may be limited to data or memory accesses for a particular queue or memory region. In various embodiments, these levels of granularity may include: per command or memory access, Queue Pair identifier (ID) (QPID), Submission Queue ID (SQID), Completion Queue ID (CQID), NVMe Controller ID (CNTID), Namespace ID (NSID), a memory address range, NVMe Stream ID, Host Identifier, NVMe Subsystem (NQN) Identifier, a time or date based level of monitoring, NVM Set ID, or other storage and network parameters. It is understood that the above are merely a few illustrative examples to which the disclosed subject matter is not limited.

Conversely, the system 101 may illustrate an embodiment in which an intermediate or intervening storage management circuit 104. In such an embodiment, the system 100 may include the host device 102, as described above. However, while not including the intermediate or intervening storage management circuit 104, the system 101 may include the storage device 116.

In such an embodiment, the storage device 116 may include the statistic monitor circuit 126, in addition to the controller 124 and the memory cells 122. In various embodiments, the integration within the storage device 116 or even the controller 124 may allow the statistic monitor circuit 126 an even more detailed view of the memory access and how it affects the memory cells. In such an embodiment, even more statistics may be recoverable or monitorable. It is understood that the above is merely one illustrative example to which the disclosed subject matter is not limited.

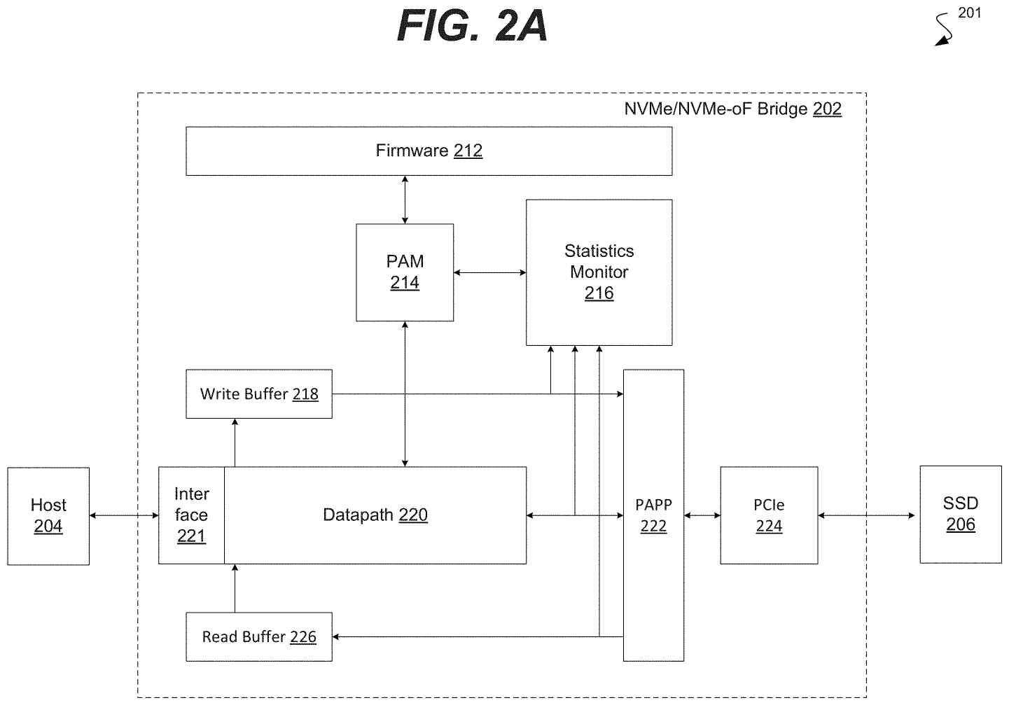

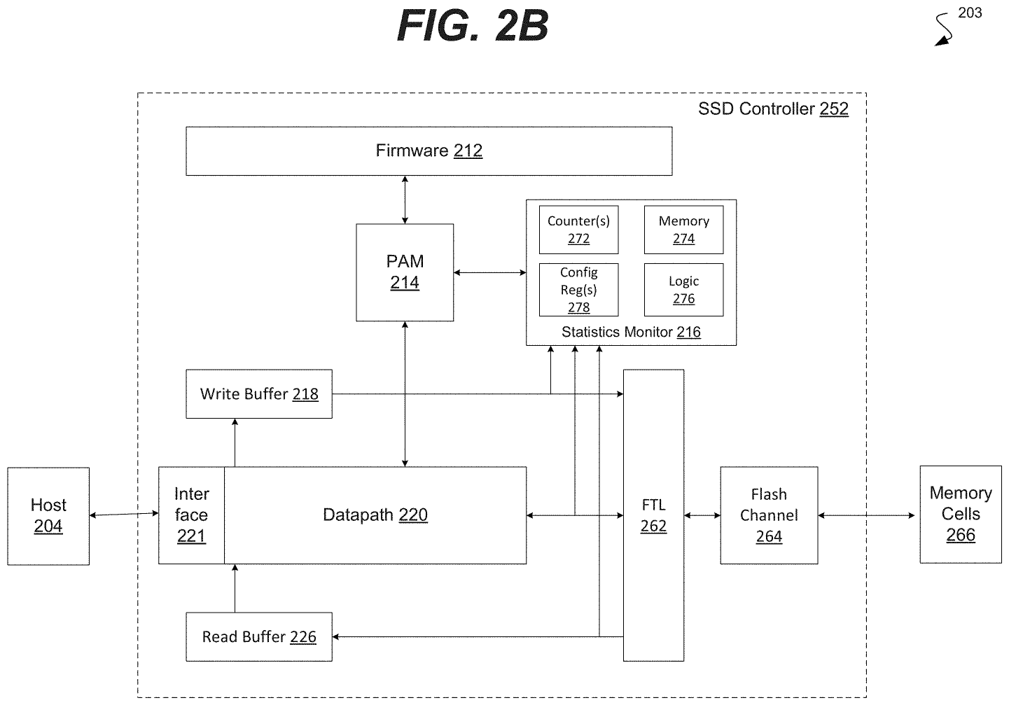

FIG. 2A is a block diagram of an example embodiment of a system 201 in accordance with the disclosed subject matter. In the illustrated embodiment, the statistics monitor circuit may be included in an intermediate storage management circuit 202. In the illustrated embodiment, the intermediate NVM storage management circuit 202 may be a NVMe to NVMe bridge or a NVMe to NVMe over Fabrics (NVMe-of) bridge. It is understood that the above is merely one illustrative example to which the disclosed subject matter is not limited, and that the communication path between the host device 204 and storage device 206 may employ various transport layers or fabrics.

In the illustrated embodiment, the system 201 may include a host device 204 and an SSD or storage memory 206, as described above. The system 201 may also include the intermediate NVM storage management circuit or NVMe to NVMe or NVMe to NVMe-of Bridge 202.

In such an embodiment, the NVMe/NVMe or NVMe/NVMe-of Bridge 202 may include an interface 221 to the host device 204. The interface 221 may be configured to communicate, especially memory accesses, between the host device 204 and the NVMe/NVMe-of Bridge 202. The NVMe/NVMe-of Bridge 202 may include a datapath 220 which transmits data associated with the memory access across the NVMe/NVMe-of Bridge 202 and between the host device 204 and storage memory 206. The NVMe/NVMe-of Bridge 202 may include a write buffer 218 and a read buffer 226 to support (via temporary storage of data) the memory access. In the illustrated embodiment, the NVMe/NVMe-of Bridge 202 may also include the processor access module (PAM) 214 and firmware 212 (executed by the PAM 214) configured to aid in the memory access.

In the normal path of memory access operation, the data associated with the memory access may travel through the datapath 220 to the PCI translation application or circuit (PAPP) 222 and then to the storage interface (in this case, PCIe interface) 224. In such an embodiment, the storage interface 224 may transmit the memory access (and the data) to the storage device 206.

In the illustrated embodiment, the NVMe/NVMe-of Bridge 202 may also include the statistics monitor circuit 216. As illustrated the statistics monitor circuit 216 may receive the command and data signals that transmit the memory access. In such an embodiment, the statistics monitor circuit 216 may be capable of monitoring the memory access as it is completed, in process, or in-flight. As described above, the statistics monitor circuit 216 may be capable of monitoring and recording a number of statistics about the memory accesses.

FIG. 2B is a block diagram of an example embodiment of a system 203 in accordance with the disclosed subject matter. In the illustrated embodiment, the statistics monitor circuit may not include in an intermediate storage management circuit 202. Instead the statistics monitor circuit 216 may be included into the controller 252 of a NVM device (e.g., an SSD). It is understood that the above is merely one illustrative example to which the disclosed subject matter is not limited, and that the communication path between the host device 204 and memory cells 266 may employ various transport layers or fabrics.

In the illustrated embodiment, the system 203 may include a host device 204, as described above. The system 203 may include memory cells 226 as the controller 252 and memory cells 266 may both be part of the storage device or SSD. The system 203 may also include the controller 252. In the illustrated embodiment, the controller 252 may include the host interface 221, the datapath 220, the write buffer 218, the read buffer 226, the firmware 212, and the PAM 214, as described above. In various embodiments, the controller 252 may include a processor (not shown).

In various embodiments, the controller 252 may also include a Flash translation layer circuit 262 and a flash channel interface 264. In such an embodiment, these two circuits 262 and 264 may translate the memory access from the protocol of the host (e.g., NVMe) to the protocol of the memory cells 266 or Flash memory. It is understood that the above is merely one illustrative example to which the disclosed subject matter is not limited.

In the illustrated embodiment, the controller 252 may also include the statistics monitor circuit 216, as described above. In the illustrated embodiment, additional inter-workings of the statistics monitor circuit 216 are described. In various embodiments, the statistics monitor circuit 216 may include one or more counters 272 configured to count (e.g., via incrementing, decrementing, addition or subtraction) the various running totals of the statistics the statistics monitor circuit 216 is configured to monitor. The statistics monitor circuit 216 may include a memory 274 to store the various statistics. In various embodiments, statistics monitor circuit 216 may include logic circuits 276 to analysis the memory accesses or the data thereof. For example, in one embodiment, the logic circuits 276 may be configured to perform frequency analysis to aid in compression analysis, as described above. In the illustrated embodiment, the statistics monitor circuit 216 may include one or more configuration registers 278 to store the configuration data as the host device 204 instructs the statistics monitor circuit 216 which statistics to monitor.

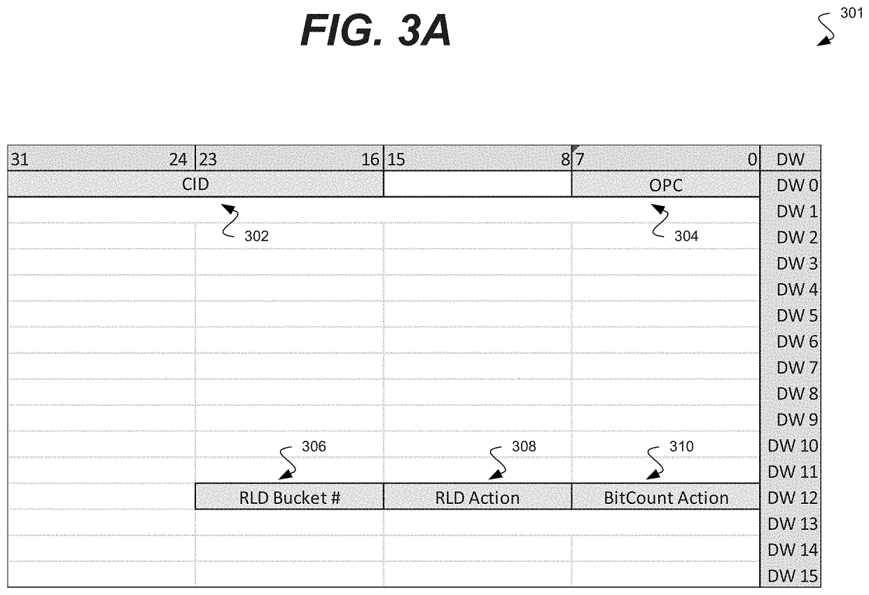

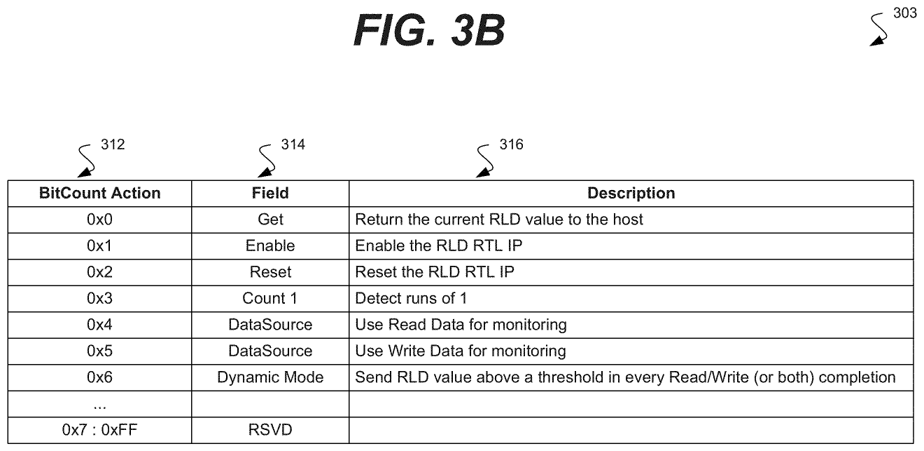

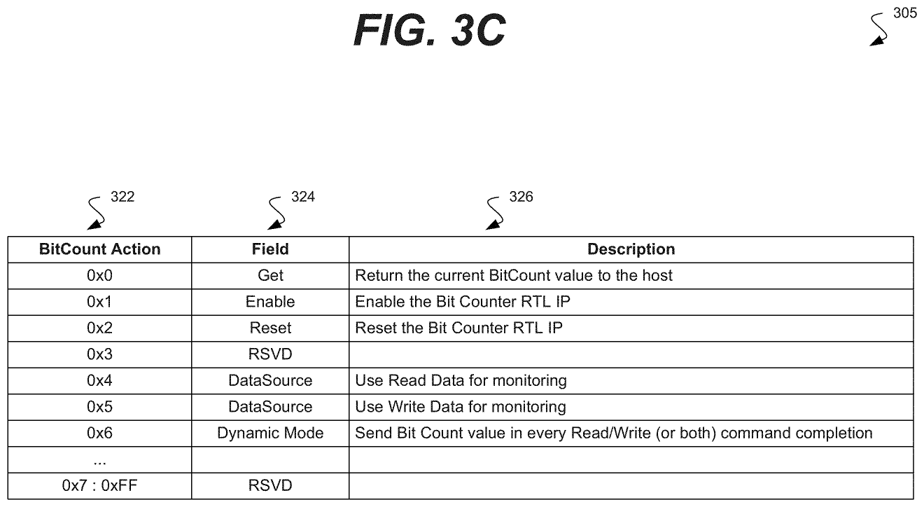

FIG. 3A is a diagram of an example embodiment of a data structure 301 in accordance with the disclosed subject matter. In various embodiments, the host device or storage driver may issue a command to the statistics monitor to configure its operation.

In the illustrated embodiment, the data structure 301 illustrates a command that may be issued to the statistics monitor. In various embodiments, the fields described herein may be part of the request phase or message of a memory access or may be a different special command.

In the illustrated embodiment, the data stricture may include 16 double words (Dwords or DW) arranged as rows (DW0-DW15). Each double word may include 32 bits, arranged horizontally. Bits, fields, or portions not illustrated or described may, in some embodiments, be reserved or generally not germane to the immediate discussion.

In the illustrated embodiment, field 302 (DW0, bits 16-31) may include the command identifier (CID) that identifies this command from another. In various embodiments, the field 304 (DW0, bits 0-7) may include the operation code (opcode or OPC) of this memory access. In various embodiments, the OPC may include a read or a write command or may include a command that sets configuration settings.

In the illustrated embodiment, the data structure 301 may include fields that specifically address the statistic monitor circuit's ability to monitor bit counts and RLDs. Specifically, field 306 (DW 12, bits 16-23) may indicate which RLD bucket or group is to follow the action instruction given the RLD action field 308 (DW12, bits 8-15). Examples of possible RLD actions are shown in FIG. 3B and described below. Field 310 (DW 12, bits 0-7) may indicate what action is to be taken in regard to monitoring the bit count. Examples of possible bit count actions are shown in FIG. 3C and described below.

In various embodiments, if other statistical data is to be monitored, other fields may be employed. If the forms of possible statistical data is great enough, then the fields employed may indicate both what action is to be taken and to what statistical data the action applies. In such an embodiment, the fields may be generic enough to support a host of statistical data collection. It is understood that the above are merely a few illustrative examples to which the disclosed subject matter is not limited.

FIG. 3B is a table 303 of an example embodiment of commands in accordance with the disclosed subject matter. In the illustrated embodiment, various possible actions or commands related to RLD monitoring are shown.

In the illustrated embodiment, column 312 illustrates the numerical code that may be included in the RLD action field. Column 314 illustrates a short human understandable description of the code. Whereas, column 316 provides a more detailed human understandable description of the code. It is understood that the above are merely a few illustrative examples to which the disclosed subject matter is not limited.

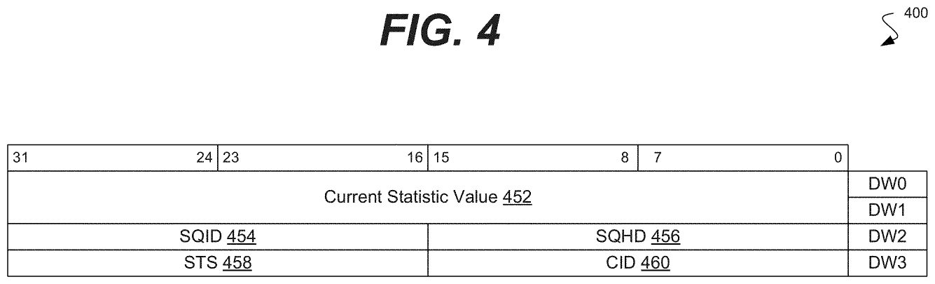

In one embodiment, the Get command or action may cause the statistics monitor circuit to return the current value of the RLD group or bucket. The Enable command or action may cause the statistics monitor circuit to start monitoring and recording RLD data. Likewise, a similar command may cause the statistics monitor circuit to stop monitoring. The Reset command or action may cause the statistics monitor circuit to reset all recorded RLD data. The “Count 1” action or command may cause the statistics monitor circuit to only count runs that include the value 1. The DataSource actions or commands may cause the statistics monitor circuit to limit its monitoring to the data included in the immediate memory access. The “Dynamic Mode” action or command may cause the statistics monitor circuit to only send the RLD value back to the host device if it exceeds a threshold value. Dynamic operation is discussed in more detail in relation to FIG. 4. Other code values may be reserved (RSVD). It is understood that the above are merely a few illustrative examples to which the disclosed subject matter is not limited.

FIG. 3C is a table 305 of an example embodiment of commands in accordance with the disclosed subject matter. In the illustrated embodiment, various possible actions or commands related to bit count monitoring are shown.

In the illustrated embodiment, column 322 illustrates the numerical code that may be included in the BitCount action field. Column 324 illustrates a short human understandable description of the code. Whereas, column 326 provides a more detailed human understandable description of the code. It is understood that the above are merely a few illustrative examples to which the disclosed subject matter is not limited.

In one embodiment, the Get command or action may cause the statistics monitor circuit to return the current value of the monitored bit count. The Enable command or action may cause the statistics monitor circuit to start monitoring and recording bit count data. Likewise, a similar command may cause the statistics monitor circuit to stop monitoring. The Reset command or action may cause the statistics monitor circuit to reset all recorded bit count data. The DataSource actions or commands may cause the statistics monitor circuit to limit its monitoring to the data included in the immediate memory access. The “Dynamic Mode” action or command may cause the statistics monitor circuit to send the bit count back to the host device as part of every response phase or message of the memory access. Dynamic operation is discussed in more detail in relation to FIG. 4. Other code values may be reserved (RSVD). It is understood that the above are merely a few illustrative examples to which the disclosed subject matter is not limited.

FIG. 4 is a diagram of an example embodiment of a data structure 400 in accordance with the disclosed subject matter. In various embodiments, the host device or storage driver may issue a command to the statistics monitor to configure its operation.

In the illustrated embodiment, the data structure 400 illustrates a response that may be issued by the statistics monitor circuit (or the device that includes the statics monitor circuit). In various embodiments, the fields described herein may be part of the response phase or message of a memory access or may be a different special command. In various embodiments, the statistics monitor circuit (or the device that includes the statics monitor circuit) may report its results dynamically or as part of every response message or phase of a relevant memory access. In various embodiments, this dynamic mode may be turned on or off, as described above.

In the illustrated embodiment, the data structure may include 4 double words (Dwords or DW) arranged as rows (DW0-DW3). Each double word may include 32 bits, arranged horizontally. Bits, fields, or portions not illustrated or described may, in some embodiments, be reserved or generally not germane to the immediate discussion.

In the illustrated embodiment, field 460 (DW3, bits 16-0) may include the command identifier (CID) that identifies which command this response is associated with. Likewise, field 454 (DW 2, bits 16-31 may include the submission queue ID (SQID). In various embodiments, a storage device may include a number of submission queues, and the SQID is employed to correlate the command with a particular submission queue. Field 456 (DW2, bits 0-15) may include the submission queue header pointer (SQHD) that indicates the number of memory accesses in the particular submission queue. The field 458 (DW 3, bits 16-31) may include the status (STS) identifier that indicates whether the memory access was successful, a failure, or otherwise. It is understood that the above are merely a few illustrative examples to which the disclosed subject matter is not limited.

In the illustrated embodiment, the field 452 (DW0 and DW1, bits 0-31) may include the current statistic value. For example, using the data structure of FIG. 3A, the host device turned on dynamic mode for RLD monitoring, the field 452 may include the current RLD count, or the RLD count associated with the memory access. Likewise, the current value of the bit count may be returned. In various embodiments, only one statistic may be in dynamic mode at a time. In another embodiment, multiple fields 452 may exist for a given data structure 400 and each may be associated with a given statistic. In such an embodiment, that association may be fixed, adjustable by the host device, or based on the context of the memory access. In various embodiments, which statistic is associated with the field 452 may change for each memory access based upon the command given (e.g., via data structure 301 of FIG. 3A). It is understood that the above are merely a few illustrative examples to which the disclosed subject matter is not limited.

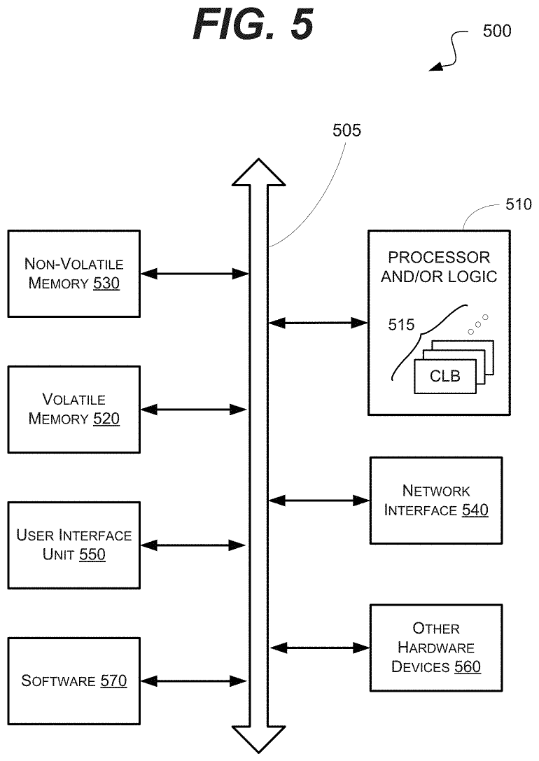

FIG. 5 is a schematic block diagram of an information processing system 500, which may include semiconductor devices formed according to principles of the disclosed subject matter.

Referring to FIG. 5, an information processing system 500 may include one or more of devices constructed according to the principles of the disclosed subject matter. In another embodiment, the information processing system 500 may employ or execute one or more techniques according to the principles of the disclosed subject matter.

In various embodiments, the information processing system 500 may include a computing device, such as, for example, a laptop, desktop, workstation, server, blade server, personal digital assistant, smartphone, tablet, and other appropriate computers or a virtual machine or virtual computing device thereof. In various embodiments, the information processing system 500 may be used by a user (not shown).

The information processing system 500 according to the disclosed subject matter may further include a central processing unit (CPU), logic, or processor 510. In some embodiments, the processor 510 may include one or more functional unit blocks (FUBs) or combinational logic blocks (CLBs) 515. In such an embodiment, a combinational logic block may include various Boolean logic operations (e.g., NAND, NOR, NOT, XOR), stabilizing logic devices (e.g., flip-flops, latches), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 500 according to the disclosed subject matter may further include a volatile memory 520 (e.g., a Random Access Memory (RAM)). The information processing system 500 according to the disclosed subject matter may further include a non-volatile memory 530 (e.g., a hard drive, an optical memory, a NAND or Flash memory). In some embodiments, either the volatile memory 520, the non-volatile memory 530, or a combination or portions thereof may be referred to as a “storage medium”. In various embodiments, the volatile memory 520 and/or the non-volatile memory 530 may be configured to store data in a semi-permanent or substantially permanent form.

In various embodiments, the information processing system 500 may include one or more network interfaces 540 configured to allow the information processing system 500 to be part of and communicate via a communications network. Examples of a Wi-Fi protocol may include, but are not limited to, Institute of Electrical and Electronics Engineers (IEEE) 802.11g, IEEE 802.11n. Examples of a cellular protocol may include, but are not limited to: IEEE 802.16m (a.k.a. Wireless-MAN (Metropolitan Area Network) Advanced, Long Term Evolution (LTE) Advanced, Enhanced Data rates for GSM (Global System for Mobile Communications) Evolution (EDGE), Evolved High-Speed Packet Access (HSPA+). Examples of a wired protocol may include, but are not limited to, IEEE 802.3 (a.k.a. Ethernet), Fibre Channel, Power Line communication (e.g., HomePlug, IEEE 1901). It is understood that the above are merely a few illustrative examples to which the disclosed subject matter is not limited.

The information processing system 500 according to the disclosed subject matter may further include a user interface unit 550 (e.g., a display adapter, a haptic interface, a human interface device). In various embodiments, this user interface unit 550 may be configured to either receive input from a user and/or provide output to a user. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

In various embodiments, the information processing system 500 may include one or more other devices or hardware components 560 (e.g., a display or monitor, a keyboard, a mouse, a camera, a fingerprint reader, a video processor). It is understood that the above are merely a few illustrative examples to which the disclosed subject matter is not limited.

The information processing system 500 according to the disclosed subject matter may further include one or more system buses 505. In such an embodiment, the system bus 505 may be configured to communicatively couple the processor 510, the volatile memory 520, the non-volatile memory 530, the network interface 540, the user interface unit 550, and one or more hardware components 560. Data processed by the processor 510 or data inputted from outside of the non-volatile memory 530 may be stored in either the non-volatile memory 530 or the volatile memory 520.

In various embodiments, the information processing system 500 may include or execute one or more software components 570. In some embodiments, the software components 570 may include an operating system (OS) and/or an application. In some embodiments, the OS may be configured to provide one or more services to an application and manage or act as an intermediary between the application and the various hardware components (e.g., the processor 510, a network interface 540) of the information processing system 500. In such an embodiment, the information processing system 500 may include one or more native applications, which may be installed locally (e.g., within the non-volatile memory 530) and configured to be executed directly by the processor 510 and directly interact with the OS. In such an embodiment, the native applications may include pre-compiled machine executable code. In some embodiments, the native applications may include a script interpreter (e.g., C shell (csh), AppleScript, AutoHotkey) or a virtual execution machine (VM) (e.g., the Java Virtual Machine, the Microsoft Common Language Runtime) that are configured to translate source or object code into executable code which is then executed by the processor 510.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. An apparatus comprising:
a host interface circuit configured to facilitate communication of memory accesses, for a storage memory, between the apparatus and a host device;
a statistics monitor circuit configured to record, as the memory accesses occur, statistics regarding data associated with the memory accesses; and
a memory interface circuit configured to communicate the memory accesses between the apparatus and at least one storage memory.

2. The apparatus of claim 1, wherein the statistics monitor circuit is configured to determine a run length distribution (RLD) of a first memory access from the memory accesses; and
wherein the statistics monitor circuit determines the run length distribution of the first memory access as data of the memory access is transferred between the host device and the storage memory.

3. The apparatus of claim 1, wherein the statistics monitor circuit is configured to include information regarding selected statistics as part of a response message, to the host device, of a memory access.

4. The apparatus of claim 1, wherein the host interface circuit is configured to:
receive, as part of a memory access, instructions for the statistics monitor circuit regarding which statistics to monitor, and
forward at least information of the instructions to the statistics monitor circuit; and
wherein the statistics monitor circuit is configured to dynamically alter a behavior of the statistics monitor circuit based, at least in part, upon the information of the instructions.

5. The apparatus of claim 1, wherein the statistics monitor circuit performs operations comprising:
maintaining a number of bits programmed per storage memory, and
computing an estimated endurance of the storage memory; and
wherein the statistics monitor circuit determines the number of bits programmed per storage memory as data of a memory access is being transferred between the host device and the at least one storage memory.

6. The apparatus of claim 1, wherein statistics monitor circuit is configured to record statistics based on a predefined group associated with a parameter of the memory accesses, and
wherein the parameter is selected from a group consisting of: a run length count, a number of bits flipped to a value, and a particular queue.

7. The apparatus of claim 1 wherein the host interface circuit is configured to:
determine that the statistics monitor circuit is configured to provide dynamic feedback to the host device,
retrieve at least one set of statistics information from the statistics monitor circuit and incorporate that set of statistics into a memory access response message to the host device.

8. The apparatus of claim 1, wherein the apparatus comprises a storage device; and
wherein the storage device comprises:
the storage memory, and
a controller including the host interface circuit, the statistics monitor circuit, and the memory interface circuit.

9. A system comprising:
a host device configured to process instructions and, via a storage driver, issue memory accesses;
an intermediate memory manager circuit comprising:
a host interface circuit configured to facilitate communication of memory accesses, for a storage memory, between the intermediate memory manager circuit and the host device,
a statistics monitor circuit configured to record, as the memory accesses occur, statistics regarding the memory accesses, and
a memory interface circuit configured to facilitate communication of the memory accesses between the intermediate memory manager circuit and at least one storage memory; and
at least one storage memory configured to store data and process memory accesses.

10. The system of claim 9, wherein the host device is capable of recording statistics regarding the memory accesses, but is configured to offload the recording of statistics to the statistics monitor circuit.

11. The system of claim 10, wherein the host device is configured to offload the recording of statistics to the statistics monitor circuit by:
transmitting a message to the intermediate memory manager circuit that indicates that the statistics monitor circuit is to record, as the memory accesses occur, statistics regarding the memory accesses, and what statistics the statistics monitor circuit is to record.

12. The system of claim 9, wherein statistics monitor circuit performs operations comprising:
recording, as the memory accesses occur, statistics regarding a run length distribution (RLD) of respective memory accesses, and
providing dynamic feedback to the storage driver regarding the run length distribution of the memory accesses; and
wherein the storage driver is configured to, based at least in part upon the dynamic feedback, determine whether or not to compress data associated with future memory accesses.

13. The system of claim 12, wherein storage driver is configured to instruct a storage memory to compress data associated with future memory accesses, and, based at least in part upon the dynamic feedback, to select one of a plurality of data compression techniques to be employed when compressing the data.

14. The system of claim 9, wherein statistics monitor circuit is configured to:
record, as the memory accesses occur, statistics regarding a number of bits flipped per storage memory, and
provide dynamic feedback to the storage driver regarding the number of bits flipped; and
wherein the storage driver is configured to, based at least in part upon the dynamic feedback, determine whether or not to scramble data associated with future memory accesses.

15. The system of claim 14, wherein at least one storage memory includes a first storage memory and a second storage memory;
wherein the storage driver is configured to, based at least in part upon a number of bits flipped by the first storage memory:
determine if the number of bits flipped by the first storage memory exceeds a threshold value, and
responsive to a determination either direct a memory access to the second memory storage, or direct a memory access to the first memory storage.

16. The system of claim 14, wherein the storage driver is configured to, based at least in part upon a number of bits flipped by a target storage memory, instruct the target storage memory to scramble data associated with a write memory access.

17. The system of claim 9, wherein the host device is configured to periodically query the intermediate memory manager circuit to retrieve one or more statistics from the statistics monitor circuit.

18. The system of claim 9, wherein the intermediate memory manager circuit comprises a non-volatile memory host controller interface bridge circuit.

19. An apparatus comprising:
a processor configured to process instructions and generate memory accesses; and
a storage management circuit configured to:
offload collection of statistics associated with a storage device to an external statistics monitor circuit,
dynamically receive information regarding the statistics as part of a response to a memory access, initiated by the storage management circuit, and
based at least in part upon the statistics, alter future memory accesses.

20. The apparatus of claim 19, wherein the storage management circuit configured to:
offload collection of statistics regarding run length distribution (RLD) of respective memory accesses;
dynamically receive information regarding the run length distribution of write memory accesses; and
based at least in part upon the run length distribution, instruct a target storage device to compress data associated with a subsequent write memory access.
